(19) United States
(12) Patent Application Publication
(10) Pub. No.: US 2025/0369759 A1
(43) Pub. Date: Dec. 4, 2025

(54) System, Method, and Apparatus for Generating Dynamic Routes in a Transportation Network

(71) Applicant: Carnegie Mellon University, Pittsburgh, PA (US)

(72) Inventors: Sean Z. Qian, Pittsburgh, PA (US); Zemian Ke, Pittsburgh, PA (US)

(21) Appl. No.: 19/223,877

(22) Filed: May 30, 2025

Related U.S. Application Data
(60) Provisional application No. 63/654,172, filed on May 31, 2024.

(51) Int. Cl. G01C 21/34; G06Q 50/47

(52) U.S. Cl. CPC G01C 21/3415; G06Q 50/47

(57) ABSTRACT

Provided is a system, method, and device for generating dynamic routes in a transportation network. The system includes a processor configured to receive a transportation request comprising an origin and a destination within a transportation network, determine a plurality of routes from the origin to the destination, wherein a first route of the plurality of routes comprises at least one optimal route among the plurality of routes, determine, for at least a subset of routes of the plurality of routes, an offset value based on traffic demand data in the transportation network, the offset value provided by a system separate and remote from the computing device, determine a selected route of the plurality of routes, allocate the offset value corresponding to the selected route to the transportation request, and modify trip data for the selected route based on the offset value.

### CROSS REFERENCE TO RELATED APPLICATION

This application claims the benefit of U.S. Provisional Patent Application No. 63/654,172 filed on May 31, 2024, the disclosure of which is hereby incorporated by reference in its entirety.

### GOVERNMENT RIGHTS NOTICE

This invention was made with government support under 1931827 awarded by the National Science Foundation (NSF). The government has certain rights in the invention.

### BACKGROUND

### 1. Field

This disclosure relates generally to vehicle transportation networks and, in non-limiting embodiments, to systems, apparatuses, and methods for generating dynamic routes in a transportation network.

### 2. Technical Considerations

With the penetration of ride-hailing and other transportation services, the impacts of transportation service providers (e.g., transportation network companies) on network performance grow. Transportation service providers comes with a ubiquitous sensing and pricing system that may be leveraged by public agencies to improve transportation system performance.

Transportation systems are designed for all: to meet the travel needs of individuals, as well as to connect and support regional economies. Transportation management systems, however, face unprecedented challenges due to increasing congestion, emissions, energy use, and infrastructure deterioration. Solutions have been proposed and deployed to address those challenges but are not desirable to all stakeholders. Transportation systems are largely driven by uncoordinated (and selfish) travelers' decisions that result in traffic states at the busiest times and locations that can be far away from a social system optimum. This calls for controlling demand, oftentimes in the form of incentivizing travelers to align their behaviors, with broad objectives such as minimizing system-wide travel delays, mitigating environmental impacts, and minimizing social costs. Unfortunately, existing incentives, such as congestion pricing, tradable credits, and parking pricing, unavoidably bring in technical concerns. For example, it is often questioned that optimal incentives are difficult to derive, and existing ones lead to inefficient outcomes and disproportionate impacts. Furthermore, implementing incentives in the real world could be very costly.

### SUMMARY

According to non-limiting embodiments or aspects, provided is a method comprising: receiving, with at least one processor, a transportation request comprising an origin and a destination within a transportation network; determining, with the at least one processor, a plurality of routes from the origin to the destination, wherein a first route of the plurality of routes comprises at least one optimal route among the plurality of routes; determining, for at least a subset of routes of the plurality of routes, an offset value based on traffic demand data in the transportation network, the offset value provided by a system separate and remote from the at least one processor; determining, with the at least one processor, a selected route of the plurality of routes; allocating, with the at least one processor, the offset value corresponding to the selected route to the transportation request; and modifying, with the at least one processor, trip data for the selected route based on the offset value.

In non-limiting embodiments or aspects, the selected route is determined based on a user selection of the selected route from the subset of routes on a user computing device. In non-limiting embodiments or aspects, the offset value for each route is based on at least one of the following: a difference in distance between the route and the at least one optimal route, a difference in travel time between the route and the at least one optimal route, a difference in traffic congestion between the route and the at least one optimal route, or any combination thereof. In non-limiting embodiments or aspects, the offset value is at least partially determined by a system separate and remote from the at least one processor. In non-limiting embodiments or aspects, wherein modifying the trip data comprises at least one of the following: adding a credit, reducing a user fee, increasing a user fee, or any combination thereof. In non-limiting embodiments or aspects, the traffic demand data comprises: (i) first traffic data associated with a fleet of vehicles assigned transportation requests in the transportation network by the at least one processor, and (ii) second traffic data associated with vehicles that are not part of the fleet of vehicles. In non-limiting embodiments or aspects, the offset value for each route is based on an algorithm configured to iteratively adjust an offset vector based on a determined equilibrium of the first traffic data and the second traffic data, such that each offset value is based on the offset vector. In non-limiting embodiments or aspects, the offset value for each route is based on one or more values associated with each segment of a plurality of segments in the transportation network.

According to non-limiting embodiments or aspects, provided is a system comprising at least one computing device configured to: receive a transportation request comprising an origin and a destination within a transportation network; determine a plurality of routes from the origin to the destination, wherein a first route of the plurality of routes comprises at least one optimal route among the plurality of routes; determine, for at least a subset of routes of the plurality of routes, an offset value based on traffic demand data in the transportation network, the offset value provided by a system separate and remote from the at least one computing device; determine a selected route of the plurality of routes; allocate the offset value corresponding to the selected route to the transportation request; and modify trip data for the selected route based on the offset value.

In non-limiting embodiments or aspects, the selected route is determined based on a user selection of the selected route from the subset of routes on a user computing device. In non-limiting embodiments or aspects, the offset value for each route is based on at least one of the following: a difference in distance between the route and the at least one optimal route, a difference in travel time between the route and the at least one optimal route, a difference in traffic congestion between the route and the at least one optimal route, or any combination thereof. In non-limiting embodiments or aspects, the offset value is at least partially determined by a system separate and remote from the at least one processor. In non-limiting embodiments or aspects, wherein modifying the trip data comprises at least one of the following: adding a credit, reducing a user fee, increasing a user fee, or any combination thereof. In non-limiting embodiments or aspects, the traffic demand data comprises: (i) first traffic data associated with a fleet of vehicles assigned transportation requests in the transportation network by the at least one processor, and (ii) second traffic data associated with vehicles that are not part of the fleet of vehicles. In non-limiting embodiments or aspects, the offset value for each route is based on an algorithm configured to iteratively adjust an offset vector based on a determined equilibrium of the first traffic data and the second traffic data, such that each offset value is based on the offset vector. In non-limiting embodiments or aspects, the offset value for each route is based on one or more values associated with each segment of a plurality of segments in the transportation network.

According to non-limiting embodiments or aspects, provided is a computer program product comprising a non-transitory computer-readable medium including program instructions that, when executed by at least one computing device, cause the computing device to: receive a transportation request comprising an origin and a destination within a transportation network; determine a plurality of routes from the origin to the destination, wherein a first route of the plurality of routes comprises at least one optimal route among the plurality of routes; determine, for at least a subset of routes of the plurality of routes, an offset value based on traffic demand data in the transportation network, the offset value provided by a system separate and remote from the computing device; determine a selected route of the plurality of routes; allocate the offset value corresponding to the selected route to the transportation request; and modify trip data for the selected route based on the offset value.

In non-limiting embodiments or aspects, the selected route is determined based on a user selection of the selected route from the subset of routes on a user computing device. In non-limiting embodiments or aspects, the offset value for each route is based on at least one of the following: a difference in distance between the route and the at least one optimal route, a difference in travel time between the route and the at least one optimal route, a difference in traffic congestion between the route and the at least one optimal route, or any combination thereof. In non-limiting embodiments or aspects, the offset value is at least partially determined by a system separate and remote from the at least one processor.

Other preferred and non-limiting embodiments or aspects of the present invention will be set forth in the following numbered clauses:

Clause 1: A method comprising: receiving, with at least one processor, a transportation request comprising an origin and a destination within a transportation network; determining, with the at least one processor, a plurality of routes from the origin to the destination, wherein a first route of the plurality of routes comprises at least one optimal route among the plurality of routes; determining, for at least a subset of routes of the plurality of routes, an offset value based on traffic demand data in the transportation network, the offset value provided by a system separate and remote from the at least one processor; determining, with the at least one processor, a selected route of the plurality of routes; allocating, with the at least one processor, the offset value corresponding to the selected route to the transportation request; and modifying, with the at least one processor, trip data for the selected route based on the offset value.

Clause 2: The method of clause 1, wherein the selected route is determined based on a user selection of the selected route from the subset of routes on a user computing device.

Clause 3: The method of any of clauses 1-2, wherein the offset value for each route is based on at least one of the following: a difference in distance between the route and the at least one optimal route, a difference in travel time between the route and the at least one optimal route, a difference in traffic congestion between the route and the at least one optimal route, or any combination thereof.

Clause 4: The method of any of clauses 1-3, wherein the offset value is at least partially determined by a system separate and remote from the at least one processor.

Clause 5: The method of any of clauses 1-4, wherein modifying the trip data comprises at least one of the following: adding a credit, reducing a user fee, increasing a user fee, or any combination thereof.

Clause 6: The method of any of clauses 1-5, wherein the traffic demand data comprises: (i) first traffic data associated with a fleet of vehicles assigned transportation requests in the transportation network by the at least one processor, and (ii) second traffic data associated with vehicles that are not part of the fleet of vehicles.

Clause 7: The method of any of clauses 1-6, wherein the offset value for each route is based on an algorithm configured to iteratively adjust an offset vector based on a determined equilibrium of the first traffic data and the second traffic data, such that each offset value is based on the offset vector.

Clause 8: The method of any of clauses 1-7, wherein the offset value for each route is based on one or more values associated with each segment of a plurality of segments in the transportation network.

Clause 9: A system comprising at least one computing device configured to: receive a transportation request comprising an origin and a destination within a transportation network; determine a plurality of routes from the origin to the destination, wherein a first route of the plurality of routes comprises at least one optimal route among the plurality of routes; determine, for at least a subset of routes of the plurality of routes, an offset value based on traffic demand data in the transportation network, the offset value provided by a system separate and remote from the at least one computing device; determine a selected route of the plurality of routes; allocate the offset value corresponding to the selected route to the transportation request; and modify trip data for the selected route based on the offset value.

Clause 10: The system of clause 9, wherein the selected route is determined based on a user selection of the selected route from the subset of routes on a user computing device.

Clause 11: The system of any of clauses 9-10, wherein the offset value for each route is based on at least one of the following: a difference in distance between the route and the at least one optimal route, a difference in travel time between the route and the at least one optimal route, a difference in traffic congestion between the route and the at least one optimal route, or any combination thereof.

Clause 12: The system of any of clauses 9-11, wherein the offset value is at least partially determined by a system separate and remote from the at least one processor.

Clause 13: The system of any of clauses 9-12, wherein modifying the trip data comprises at least one of the following: adding a credit, reducing a user fee, increasing a user fee, or any combination thereof.

Clause 14: The system of any of clauses 9-13, wherein the traffic demand data comprises: (i) first traffic data associated with a fleet of vehicles assigned transportation requests in the transportation network by the at least one processor, and (ii) second traffic data associated with vehicles that are not part of the fleet of vehicles.

Clause 15: The system of any of clauses 9-14, wherein the offset value for each route is based on an algorithm configured to iteratively adjust an offset vector based on a determined equilibrium of the first traffic data and the second traffic data, such that each offset value is based on the offset vector.

Clause 16: The system of any of clauses 9-15, wherein the offset value for each route is based on one or more values associated with each segment of a plurality of segments in the transportation network.

Clause 17: A computer program product comprising a non-transitory computer-readable medium including program instructions that, when executed by at least one computing device, cause the computing device to: receive a transportation request comprising an origin and a destination within a transportation network; determine a plurality of routes from the origin to the destination, wherein a first route of the plurality of routes comprises at least one optimal route among the plurality of routes; determine, for at least a subset of routes of the plurality of routes, an offset value based on traffic demand data in the transportation network, the offset value provided by a system separate and remote from the computing device; determine a selected route of the plurality of routes; allocate the offset value corresponding to the selected route to the transportation request; and modify trip data for the selected route based on the offset value.

Clause 18: The computer program product of clause 17, wherein the selected route is determined based on a user selection of the selected route from the subset of routes on a user computing device.

Clause 19: The computer program product of any of clauses 17-18, wherein the offset value for each route is based on at least one of the following: a difference in distance between the route and the at least one optimal route, a difference in travel time between the route and the at least one optimal route, a difference in traffic congestion between the route and the at least one optimal route, or any combination thereof.

Clause 20: The computer program product of any of clauses 17-19, wherein the offset value is at least partially determined by a system separate and remote from the at least one processor.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying figures shown in the separate attachment, in which:

FIG. 1 is a schematic diagram of a system for generating dynamic routes in a transportation network according to non-limiting embodiments or aspects;

FIG. 2 is an example map diagram used with a system for generating dynamic routes in a transportation network according to some non-limiting embodiments or aspects;

FIG. 3 is a flow diagram of a method for generating dynamic routes in a transportation network according to non-limiting embodiments or aspects;

FIG. 4 is a schematic diagram of a system for generating dynamic routes in a transportation network according to non-limiting embodiments or aspects; and

FIG. 5 illustrates a schematic diagram of components used in non-limiting embodiments or aspects.

### DETAILED DESCRIPTION

It is to be understood that the embodiments may assume various alternative variations and step sequences, except where expressly specified to the contrary. It is also to be understood that the specific devices and processes described in the following specification are simply exemplary embodiments or aspects of the disclosure. Hence, specific dimensions and other physical characteristics related to the embodiments or aspects disclosed herein are not to be considered as limiting. No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the terms “processor” or “computing device” may refer to one or more electronic devices configured to process data. A processor and/or computing device may include, for example, a Central Processing Unit (CPU), a Graphics Processing Unit (GPU), a microprocessor, a controller, and/or any other computational device capable of executing logic. A “computer readable medium” may refer to one or more memory devices or other non-transitory storage mechanisms capable of storing compiled or non-compiled program instructions for execution by one or more processors. Reference to “a processor” or “a computing device” as used herein, may refer to a previously-recited computing device and/or processor that is recited as performing a previous step or function, a different server and/or processor, and/or a combination of computing devices and/or processors. For example, as used in the specification and the claims, a first computing device and/or a first processor that is recited as performing a first step or function may refer to the same or different computing device and/or a processor recited as performing a second step or function.

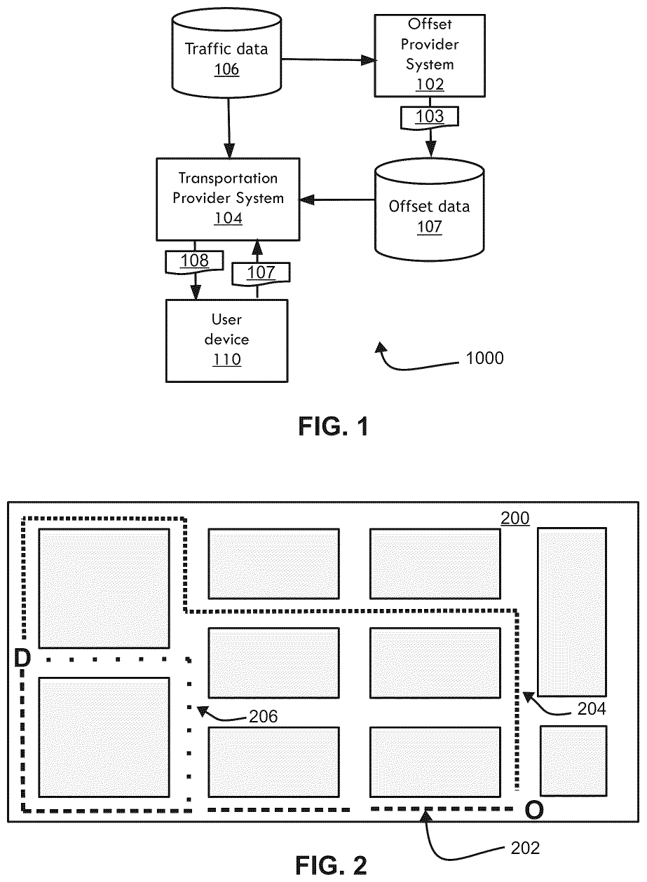

Referring to FIG. 1, shown is a system 1000 for generating dynamic routes in a transportation network according to non-limiting embodiments or aspects. A transportation provider system 104 may include, for example, one or more computing devices, such as server computers, for managing transportation requests. The transportation provider system 104 may be associated with, for example, a provider of rideshare services, delivery services, and/or any other transportation-related service. In non-limiting embodiments, multiple different transportation provider systems (not shown in FIG. 1) may be arranged in a transportation network. FIG. 1 shows an example with one transportation provider system 104 for illustration purposes. The transportation provider system 104 is in communication with a user device 110, which may include a computing device operated by a user requesting transportation services. The communication may be an Internet communication via one or more mobile applications executed with the user device 110, as an example.

With continued reference to FIG. 1, the transportation provider system 104 may also be in communication with an offset provider system 102 and/or offset data 107. The offset provider system 102 may include, for example, one or more computing devices operated by a government entity and/or another party that provides offsets, such as subsidies, credits, discounts, and/or other rewards, for customers and/or transportation provider systems to incentivize and cause increased optimization in traffic flow and congestion. The offset provider system 102 may provide offset data 103 for a plurality of segments (e.g., one or more roads or portions thereof from a transportation network), such that the offset data 103 defines a reward associated with that segment. The offset data 103 may be made available to the transportation provider system 104, for example by request (e.g., via an API call) and/or the like. The offset data 103 may be dynamic based on one or more other variables, such as real-time traffic data (e.g., traffic data during the time the requested transportation is to take place). The transportation provider system 104 and offset provider system 102 may also be in communication with traffic data 106, which may be from one or more sources such as, but not limited to, the transportation provider system 104, other transportation provider systems, publicly available data, and/or the like. Traffic data may include real-time traffic conditions, such as congestions on different roads and/or segments, delay times, road closure information, and/or the like.

Still referring to FIG. 1, a user device 110 may send a transportation request 107 to the transportation provider system 104 that includes an origin and destination, in response to which the transportation provider system 104 may obtain a plurality of possible routes and query the offset data 107 to identify one or more offsets associated with each route (e.g., associated with one or more segments of each route). A list of routes 108 may then be communicated to the user device 110 with corresponding offsets. For example, a user may be presented with a graphical user interface (GUI) displayed on a user device with a list of routes with corresponding prices, where the prices are based on the offset. A fastest and/or most optimal path may have a higher price than other routes, and the other routes may have different offset amounts (e.g., discounts, credits, and/or the like) associated with selecting that route. In this manner, a user can voluntarily opt-in to a less efficient route that helps manage the flow and equilibrium of the transportation network for a reward (e.g., lower cost). Once a route is selected, the transportation provider system 104 may modify the trip data to reflect the selected route and the price with or without offsets. The trip data may include information regarding the transportation request 107, including the origin, destination, route, fee/price, estimated time of pick-up, estimated time of drop-off, and/or the like.

Although offsets are discussed herein as discounts and/or credits to reward a selection of a less optimal route, it will be appreciated that offsets may also be used to increase the price for a more desirable and/or optimal route. In this manner, a user may be prompted to select from routes that include offsets that are more expensive than routes without offsets that may take longer and/or be less desirable. In non-limiting embodiments, offsets provided to a transportation provider system 104 and by the offset provider system 102 may be equal to or different from the offsets provided to the requestor (e.g., consumer) by the transportation provider system 104.

The number and arrangement of systems and devices shown in FIG. 1 are provided as an example. There may be additional systems and/or devices, fewer systems and/or devices, different systems and/or devices, and/or differently arranged systems and/or devices than those shown in FIG. 1.

Referring now to FIG. 2, shown is an example map diagram 200 for illustrating a system for generating dynamic routes in a transportation network according to some non-limiting embodiments or aspects. The diagram 200 shows different segments 202, 204, 206 associated with routes from the origin (O) to the destination (D). Segments may be partial routes, such as segment 206, or entire routes, such as segment 204. Some routes may include multiple segments (e.g., the route including 202 and 206). In this example, the segment 202 may be for a most optimal (e.g., fastest, desired, shortest, and/or the like) route, segment 206 may have a small offset to modify the most optimal route, and segment 204 may have the largest offset for being the least direct. As an example, any route that uses segment 204 may be provided with a set offset (e.g., $2). It will be appreciated that the example shown in FIG. 2 is for illustration purposes only.

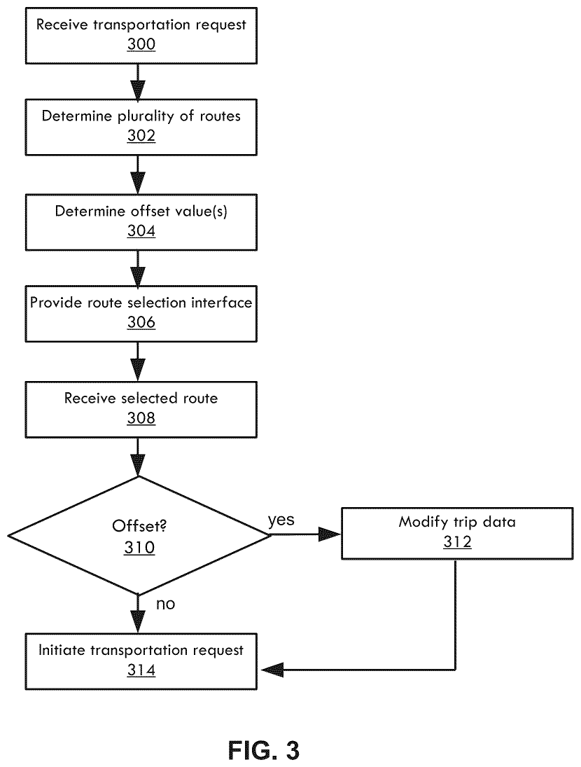

Referring now to FIG. 3, shown is a flow diagram for a method for generating dynamic routes in a transportation network according to some non-limiting embodiments or aspects. The steps shown in FIG. 3 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

At a first step 300, a transportation request may be received by a transportation provider system, such as but not limited to a delivery service, ride-hailing service, and/or the like. The transportation request may be received from a requesting customer through an application via a network connection. The transportation request may include an origin and a destination. At step 302, a plurality of routes may be determined between the origin and destination. The plurality of routes may be determined by one or more mapping algorithms and may include a variety of routes ranging in travel time and/or distance. Routes may also vary based on tolls, infrastructure (e.g., bridges), and other parameters.

At step 304, offset values are determined for at least a subset of the routes determined at step 302. For example, the transportation provider system may query an offset provider system and/or a database to obtain offset values for one or more of the routes based on the segments of each route. The offset values may be dynamically determined based on one or more algorithms at the time of the request in consideration of real-time traffic data (e.g., such as traffic demand data from the transportation provider system and/or one or more other sources). In non-limiting embodiments, the offset values may be at least partially predetermined based on historic data. In some examples a route may have multiple aggregated offset values based on offsets for different segments of the route. In non-limiting embodiments, offset values received by the transportation provider system (e.g., from an offset provider such as a public agency or the like) may be different than the offset values received by the requestor (e.g., consumer) as a discount, credit, or other like benefit. Determining one or more offset values may therefore include, in non-limiting embodiments, determining first offset value(s) for a route that will be received by the transportation provider system from an offset provider, and determining second offset value(s) that will be passed on to the requestor (e.g., consumer) that may be higher or lower than the first offset value(s) to the best interest of the transportation provider system.

In non-limiting embodiments, the transportation provider system may determine how to configure the offset value for each route option provided to a consumer based on efficiency and revenue. For example, the transportation provider system may not present every possible route and/or offset to a consumer but may instead select one or more routes and corresponding offsets based on one or more parameters. In non-limiting embodiments, the offsets may be provided to the transportation provider system in response to the trip being completed or as batches at time-based intervals. In some examples, the provision of the offsets may be conditioned on one or more performance metrics determined by travel logs and/or sensor data provided by the transportation provider system and/or one or more other entities. In such examples, the consumer may immediately receive a value of the offset, which may be equal to, greater than, or less than the value of the offset received by the transportation provider system or by the offset provider, as a credit and/or discount to a regular fare through the transportation provider system. For example, the offsets may be conditioned on reducing the congestion in a transportation network by a predetermined percentage. In other non-limiting embodiments, the offsets may be provided directly to consumers from the offset provider. It will be appreciated that various channels may be used to provide offset values to the transportation provider system and/or consumer.

At step 306, a route selection interface may be displayed to the requesting user. For example, a GUI with a plurality of selectable options corresponding to a plurality of routes may be shown to facilitate a user selection of a route. Each route may be displayed next to a cost (e.g., fare). Offset values determined at step 304 may be displayed adjacent the cost for each route and/or may be factored into the displayed cost. For example, a credit or discount of five dollars may be displayed next to a route, a credit or discount of two dollars may be displayed next to another route, and no credit or discount may be displayed next to another route (e.g., such as an optimal route). At step 308, the route selected by the user is received from the GUI.

At step 310, the transportation provider system may determine if the selected route is associated with one or more offsets. If the route includes one or more segments associated with offset values, the method may proceed to step 312 and the trip data may be modified. For example, trip data may include information regarding the transportation request, such as parameters associated in one or more databases for a transportation request including the origin, destination, route, fee/price, estimated time of pick-up, estimated time of drop-off, and/or the like, and an offset value may be added as a parameter of the trip data. After step 312, or after it is determined that no offset value is available at step 310, the method may proceed to step 314 and the transportation provider system may initiate the transportation request. For example, the transportation provider system may assign the transportation request to a vehicle, may initiate a search for available vehicles for the selected route, may confirm and/or finalize an existing or ongoing trip, and/or the like.

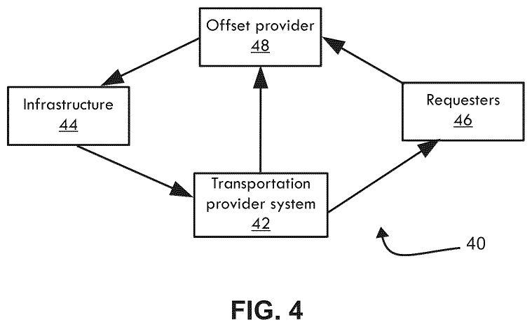

FIG. 4 shows a system for generating dynamic routes in a transportation network according to some non-limiting embodiments or aspects. The diagram shown in FIG. 4 shows the relationships and benefits between systems and/or entities. For example, requesters 46 (such as riders) help reduce total system travel time by opting into offsets for transportation requests, benefiting an offset provider 48 such as a public agency. Public agencies may set segment-based (e.g., link-based) offset values to different aspects of infrastructure 44 corresponding to the segments, such as roads, bridges, and/or the like. The infrastructure 44 affects the operation cost of the transportation provider system, which in turns benefits the requesters 46 with compensation in the form of offsets.

In non-limiting embodiments, vehicles in a transportation network are segmented into two classes of vehicles, personal driving vehicles and transportation (e.g., ride-hailing, delivery, and/or the like) vehicles. Non-limiting embodiments do not consider travel mode choices or stochastic demands but may assume the personal driving demand and transportation demand are exogenous and fixed for the purposes of analysis. The driving vehicles behave per a user equilibrium (UE) principle, while the transportation vehicles follow a certain fleet behavior which is decided by an individual transportation service provider platform as a whole. Non-limiting embodiments may use other types of routing behaviors alternatively or additionally to UE. If the transportation or other service vehicles act on their own and there is no coordination among the transportation service provider platform, then the vehicles follow UE fleet behavior, and the whole system would reach UE. Transportation service providers would be motivated to coordinate its fleet vehicles to improve fleet efficiency and/or save total travel time, also known as fleet optimum (FO) behavior. The mixed equilibrium with driving vehicles following UE and transportation vehicles following FO is denoted as ME-FO herein. Notations used in the following equations and examples are summarized in Table 1.

TABLE 1
Table of notations.

| | |
|---|---|
| A | Set of links |
| R [symbol] S | Sets of origins and destinations |
| r [symbol] s | Indices of origins and destinations |
| K [symbol] | Set of paths between OD pair rs |
| k | Index of a path |
| a | Index of a link |
| ${δ}_{a}^{rs , k}$ | ${δ}_{a}^{rs , k} = 1 if link a is on path k ∈ {K}^{rs} and 0 otherwise$ |
| ${x}_{a}^{D} , {x}_{a}^{R}$ | Driving link flow and ride-hailing link flow of link a |
| ${r}_{D}^{rs} , {q}_{R}^{rs}$ | Driving demand and ride-hailing demand of OD pair rs |
| ${f}_{D}^{rs , k} , {f}_{R}^{rs , k}$ | Driving path flow and ride-hailing path flow of path k of OD pair rs |
| x [symbol] | Total link flow of link a, total demand of OD pair rs, and total path flow of path k of OD pair rs |
| [symbol] | Link travel time of link a |
| τ [symbol] | Subsidy of link a for ride-hailing vehicles |
| ${c}_{D}^{rs , k}$ | Cost of path k of OD pair rs for driving vehicles |
| ${c}_{R}^{rs , k}$ | Cost of path k of OD pair rs for ride-hailing vehicles (the cost function used in ride-hailing routing) |
| ${cp}_{R}^{rs , k}$ | Cost of path k of OD pair rs for ride-hailing passengers |
| d [symbol] | Deviating compensation of path k of OD pair rs for ride-hailing passengers paid by TNC |
| FC | Generalized fleet cost for the fleet of ride-hailing vehicles |
| μ [symbol] | The value of time of the ride-hailing passengers (e.g., 0.5 $/min) |
| μ [symbol] | The operating cust of travel time for the ride-hailing company (e.g., 1.5 $/min) |
| μ [symbol] | The average price of ride-hailing per unit travel time (e.g., 2.0 $/min) |
| α | $Demand ratio of ride ‐ hailing vehicles such that {q}_{R}^{rs} = α {q}^{rs}$ |
| [symbol] | Subsidy of link a for ride-hailing vehicles |
| γ | Trade-off parameter of ORHP objective function |
| x [symbol] , x [symbol] , qₚ, q_{g}, f_{D}, f [symbol] | $Vectors of {x}_{a}^{D} , {x}_{a}^{R} , {q}_{D}^{rs} , {q}_{R}^{rs} {f}_{D}^{rs , k} {f}_{R}^{rs , k} . For example {x}_{D} = {( … , {x}_{a}^{D} , … )}^{T}$ |
| x, q, f | $Vectors of link , flows , demands and path flows among two classes . For example , x = {( {x}_{D}^{T} , {x}_{R}^{T} )}^{T}$ |
| d | Vector of path-based compensations, d = (. . . ,d [symbol] , . . .) [symbol] |
| r | Vector of link-based subsidies, τ = (. . . , τ [symbol] . . . ) [symbol] |

[symbol]

indicates data missing or illegible when filed

In non-limiting embodiments, offset values are determined based on conducting a simultaneous game between the transportation service provider platform vehicles and personal driving vehicles. Both the fleet of transportation vehicles and personal driving vehicles are considered players in a non-cooperative game where each player seeks to minimize their costs. Given the competition between transportation fleet and personal driving vehicles, each group of vehicles is likely to adjust their behavior in response to the other group's behavior until a stable state is reached, and because they are infinitesimal players, this is known as Wardrop Equilibrium. At a Wardrop Equilibrium, no player can improve their generalized costs by unilaterally changing their respective strategies.

In non-limiting embodiments described herein, personal driving link flows and transportation link flows (e.g., link flows for transportation vehicles that may be engaged in ride-hailing, delivery, and/or the like) are denoted as

$${x}_{D} = {( ... , {x}_{a}^{D} , ... )}^{T} and {x}_{R} = {( ... , {x}_{a}^{R} , ... )}^{T}$$

respectively, wherein

$${x}_{a}^{D} and {x}_{a}^{R}$$

denote the personal driving link flow and the transportation link flow of the link a. A link, as used herein, may be one or more segments of the transportation network. The personal driving demands and the ride hailing demands are denoted as

$${q}_{D} = {( ... , {q}_{D}^{rs} , ... )}^{T} and {q}_{R} = {( ... , {q}_{R}^{rs} , ... )}^{T}$$

respectively, wherein

$${q}_{D}^{rs} and {q}_{R}^{rs}$$

denote the personal driving demand and transportation demand of origin-destination (OD) pair rs. The personal driving path flows and transportation path flows are denoted as

$${f}_{D} = {( ... , {f}_{D}^{rs , k} , ... )}^{T} and {f}_{R} = {( ... , {f}_{R}^{rs , k} , ... )}^{T}$$

respectively, wherein

$${f}_{D}^{rs , k} and {f}_{R}^{rs , k}$$

denote the personal driving path flow and the transportation path flow on path k between OD pair rs.

In non-limiting embodiments, assuming the personal driving demands q_{D} and transportation (e.g., ride-hailing or the like) demands q_{R}, feasible sets of personal driving link flows x_{D} and transportation link flows x_{R} are determined using equations:

$$Ω\_D = \{ x\_D ⊣ \vert x\_a \hat{} D = {\sum }_{-} ( r ∈ R ) {\sum }_{-} ( s ∈ S ) {\sum }_{-} ( k ∈ K \hat{} rs ) f\_D \hat{} ( rs , k ) , δ\_a \hat{} ( rs , k ) , q \_D \hat{} rs = {\sum }_{-} ( k ∈ K \hat{} rs ) f\_D \hat{} ( rs , k ) , f\_D \hat{} ( rs , k ) \geq 0 , ∀ \_a ∈ A , r ∈ R , s ∈ S , k ∈ K \hat{} rs \} \qquad ( 1 )$$

$$Ω\_R = \{ x\_R ⊣ \vert x\_a \hat{} R = {\sum }_{-} ( r ∈ R ) {\sum }_{-} ( s ∈ S ) {\sum }_{-} ( k ∈ K \hat{} rs ) f\_R \hat{} ( rs , k ) , δ\_a \hat{} ( rs , k ) , q \_R \hat{} rs = {\sum }_{-} ( k ∈ K \hat{} rs ) f\_R \hat{} ( rs , k ) , f\_R \hat{} ( rs , k ) \geq 0 , ∀ \_a ∈ A , r ∈ R , s ∈ S , k ∈ K \hat{} rs \} \qquad ( 2 )$$

### Where

$${δ}_{a}^{rs , k} = 1$$

if link a is on path k of OD pair rs and 0 otherwise, A is the set of links, R is the set of origins r, S is the set of destinations s, and K^{rs} is the set of paths of OD pairs rs. These path flows, link flows, and demands satisfy the constraints laid out by equations:

$${x}_{a}^{D} = {\sum }_{r ∈ R} {\sum }_{s ∈ S} {\sum }_{k ∈ {K}^{rs}} {f}_{D}^{rs , k} , {δ}_{a}^{rs , k} , {x}_{a}^{R} = {\sum }_{r ∈ R} {\sum }_{s ∈ S} {\sum }_{k ∈ {K}^{rs}} {f}_{D}^{rs , k} , \\ {δ}_{a}^{rs , k} , {∀}_{a} ∈ A , r ∈ R , s ∈ S , k ∈ {K}^{rs} \qquad ( 3 a )$$

$${q}_{D}^{rs} = {\sum }_{k ∈ {K}^{rs}} {f}_{D}^{rs , k} , {q}_{R}^{rs} = {\sum }_{k ∈ {K}^{rs}} {f}_{R}^{rs , k} , ∀ r ∈ A , r ∈ R , s ∈ S , k ∈ {K}^{rs} \qquad ( 3 b )$$

$${f}_{D}^{rs , k} \geq 0 , {f}_{R}^{rs , k} \geq 0 , ∀ r ∈ R , s ∈ S , k ∈ {K}^{rs} \qquad ( 3 c )$$

In non-limiting embodiments, the personal driving vehicles are assumed to aim to minimize individual travel time given x_{R}. The below equation can be used to obtain driving flows x_{D}, where tₐ(·) is the travel time function of link a with respect to the total link flow across two classes.

$${min}_{{x}_{D} ∈ {Ω}_{D}} {\sum }_{a ∈ A} {\int }_{0}^{{x}_{a}^{D}} {t}_{a} ( x + {x}_{a}^{R} ) dx \qquad ( 4 )$$

In the case of transportation service providers adopting an FO behavior for transportation vehicles, the transportation flows may be solved by minimizing fleet travel time with the following equation:

$${min}_{{x}_{R} ∈ {Ω}_{R}} {\sum }_{a ∈ A} {\int }_{0}^{{x}_{a}^{R}} {x}_{a}^{R} {t}_{a} ( {x}_{a}^{R} + {x}_{a}^{D} ) dx \qquad ( 5 )$$

where x_{D} is given. Using these two equations (4) and (5) simultaneously leads to a solution to ME-FO.

In non-limiting embodiments, it may be assumed that link travel time function is first-order and second-order differentiable and

$${t}_{a}^{′} ( {x}_{a} ) > 0 and {t}_{a}^{″} ( {x}_{a} ) \geq 0 , ∀ a ∈ A , ∀ {x}_{a} \geq 0.$$

Based on this assumption, the objective functions of optimization problems shown as equations (4) and (5) are both convex, which means congestion increases on each link more drastically when the link flow grows.

In non-limiting embodiments, service constraint (SC) may be implemented for transportation service providers, wherein the transportation service provider pays offsets (e.g., compensation, such as subsidies, to offset the cost) to certain passengers who have chosen to deviate from their respective optimal path to save total travel time for the transportation service provider. This offset may be used to assist the transportation service provider against losing consumers and is accounted for in the total cost charged to the requesting customer

$${cp}_{R}^{rs , k} = {μ}_{u} {\sum }_{a ∈ A} {t}_{a} ( {x}_{a} ) {δ}_{a}^{rs , k} + {p}^{rs , k} - {d}^{rs , k} \qquad ( 6 )$$

where μᵤ is the value of time (VOT of riders), p^{rs,k} is the transportation fare calculated based on travel time and/or travel distance, and d^{rs,k} is the offset for anyone on path k between OD pairs rs. For simplicity, a transportation fare structure based on travel time is used, denoted as μₚ, thus

$${p}^{rs , k} = {μ}_{p} {\sum }_{a ∈ A} {t}_{a} ( {x}_{a} ) {δ}_{a}^{rs , k} ,$$

where p^{rs,k} can also be generalized to embed other factors in the following formulations.

In non-limiting embodiments, the generalized cost of any requesting customer within each OD pair must be equalized to the generalized cost of requestors (e.g., such as riders) on the path(s) with the minimum travel time:

$${μ}_{u} {\sum }_{a ∈ A} {t}_{a} ( {x}_{a} ) {δ}_{a}^{rs , k} + {p}^{rs , k} - {d}^{rs , k} = {min}_{k ∈ {K}^{rs}} ( {μ}_{p} {\sum }_{a ∈ A} {t}_{a} ( {x}_{a} ) {δ}_{a}^{rs , k} + {p}^{rs , k} ) , ∀ k ∈ {K}^{rs} \qquad ( 7 )$$

With SC in place, the optimization problem for the transportation service provider is to minimize the total generalized fleet cost, denoted as FC, determined from the total fleet total travel time and the total compensation cost:

$${min}_{{f}_{R}} FC = {u}_{t} {\sum }_{a ∈ A} {x}_{a}^{R} {t}_{a} ( {x}_{a} ) + {\sum }_{r} {\sum }_{s} {\sum }_{k} {f}_{R}^{rs , k} {d}^{rs , k} \qquad ( 8 a )$$

$$s . t . Eqs . ( 3 ) \qquad ( 8 b )$$

where personal driving demand x_{D}. This fleet assignment is referred to as fleet optimal with service constraint (FOSC). In non-limiting embodiments, the simultaneous solution to optimization problems shown in equations (4) and (8) may be a mixed equilibrium of the UE and FOSC players, denoted ME-FOSC.

In non-limiting embodiments, a transportation service provider may centrally assign routes to transportation vehicles with offsets, so the path cost function used in the routing for the transportation service provider is the marginal fleet cost:

$${c}_{R}^{rs , k} = \frac{\partial FC}{\partial {f}_{R}^{rs \cdot k}} = {μ}_{t} {\sum }_{a}^{R} ( {t}_{a} ( {x}_{a} ) + {x}_{a}^{R} {t}_{a}^{′} ( {x}_{a} ) ) {δ}_{a}^{rs , k} + d \hat{} ( rs , k ) + ( μ\_u + μ\_p ) {\sum }_{-} ( r {\hat{}}^{′} ) {\sum }_{-} ( s {\hat{}}^{′} ) {\sum }_{-} ( k {\hat{}}^{′} ) ( f\_R \hat{} ( r {\hat{}}^{′} s {\hat{}}^{′} , k {\hat{}}^{′} ) {\sum }_{-} a t\_a {\hat{}}^{′} ( x\_a ) ) δ\_a \hat{} ( rs , k ) ( δ\_a \hat{} ( r {\hat{}}^{′} s {\hat{}}^{′} , k {\hat{}}^{′} ) - δ\_a \hat{} ( r {\hat{}}^{′} s {\hat{}}^{′} , k\_ ( r {\hat{}}^{′} s {\hat{}}^{′} ) \hat{} \text{*)} ) ) \qquad ( 9 )$$

In non-limiting embodiments, the travel time may be the main consideration in the fleet cost function of FO fleet behavior, while with the FOSC fleet behavior, the fleet cost function may also consider the offset that ensures high service quality and balances fare/service time to retain consumers in a longer timeframe.

In non-limiting embodiments, ME-FO may be obtained by solving two convex problems shown in equations (4) and (5) simultaneously using a path-based method of successive average (MSA). In non-limiting embodiments, ME-FOSC may be unable to be solved with existing solution algorithms, such as MSA, due to equation (8) not being convex, as compensation d^{rs,k} is dependent on flows. In non-limiting embodiments, a heuristic solution algorithm may be used for ME-FOSC where offsets d are fixed to solve MEFOSC for paths flows f(d). Offsets d are updated using given path flows f*(d). This is done iteratively until a convergence criterion is satisfied. The total fleet cost may be dependent on fixed offsets d and may be treated as such to solve ME-FOSC. The optimization problem shown in equation (8) becomes:

$${min}_{{f}_{R}} FC ( d ) = {μ}_{t} {\sum }_{a ∈ A} {x}_{a}^{R} {t}_{a} ( {x}_{a} ) + {\sum }_{r} {\sum }_{s} {\sum }_{k} {f}_{R}^{rs , k} {d}^{rs , k} \qquad ( 10 a )$$

$$s . t . {f}_{R} satisfies constraint ( 3 ) \qquad ( 10 b )$$

with path cost function of transportation vehicles dependent on fixed offsets d:

$${c}_{R}^{rs , k} ( d ) = {μ}_{t} {\sum }_{a} ( {t}_{a} ( {x}_{a} ) + {x}_{a}^{R} {t}_{a}^{′} ( {x}_{a} ) ) {δ}_{a}^{r s . k} + {d}^{rs , k} \qquad ( 11 )$$

In non-limiting embodiments, a transportation pricing protocol (e.g., an optimal transportation pricing algorithm) is provided in which an offset provider, such as a public agency, sets the value of an offset on each link provided to the transportation service providers while not providing those links to the consumers. In non-limiting examples, for any consumer served by a transportation service provider, the transportation service provider may be subsidized for an amount that is the sum of the link-based offsets across all links along the travel path, which in turn affects the routing behaviors of the transportation vehicle to improve transportation network performance. In non-limiting embodiments, a monetary offset to transportation service providers can be issued for specific links chosen by the transportation vehicle that may be deviating (e.g., less optimal) routes. This has a similar effect to issuing a monetary surcharge or other forms of a premium fee, to a transportation vehicle on specific links, where the surcharge would result from the transportation vehicle taking the most “expensive” but efficient route passing through those links. This differs from congestion pricing schemes because consumers have options to personally drive or chose from multiple routes from transportation services priced differently, such that the system is opt-in (e.g., voluntary participation).

In non-limiting embodiments, an offset in the form of a surcharge may be used instead of, or in addition to, a subsidy offset. A subsidy-based offset may attract transportation service providers to participate in this program.

In non-limiting embodiments, for the purpose of the transportation pricing protocol, it may be assumed that transportation service providers centrally provide routing options for transportation vehicles, and the consumers are willing to choose one of the assigned routes based on three considerations: (1) With FOSC, consumers taking deviating routes will receive compensations set by transportation service providers; (2) transportation service providers may make the deviating routes even more appealing with higher compensations, if they or consumers receive offsets in the form of subsidies from public agencies that encourage routing going through links with high offsets; and (3) not every consumer has to deviate their route. In non-limiting embodiments, transportation service providers may provide each consumer with different route options on a GUI, including the most optimal (e.g., shortest in time or distance) without an offset and deviated routes with one or more offsets, encouraging enough consumers to deviate. In non-limiting embodiments, the offset provider may provide the transportation service providers with the offsets directly, in return for which the transportation service providers may provide the offset providers and/or other entities with vehicle traces (e.g., tracking logs) as evidence, along with measurements on desired total travel time/delay (or time/delay reductions). In non-limiting embodiments, the offset consumers receive may be a small fraction of their fare.

In non-limiting embodiments, the transportation pricing protocol may be modeled as a Stackelberg game, wherein the offset provider is the leader that sets offsets for transportation services, and personal-driving vehicles and transportation vehicles are the followers. The offsets affect the route choices of transportation vehicles, on top of the desired FOSC behavior for those vehicles, which further affects the route choices of personal driving vehicles due to changes in flow of the transportation network. In non-limiting embodiments, the offset provider sets and leverages transportation offsets to minimize the generalized system cost by analyzing how all vehicles respond to transportation offsets.

In non-limiting embodiments, the offset may provide a subsidy of τₐ to a transportation service provider platform for any consumer passing through the link a once. This offset may be provided as a part of the service fare. With the transportation pricing protocol in place, a transportation service provider platform may route their transportation vehicles by incorporating the added benefits into FOSC. The transportation routing problem (8) is modified here as

$${min}_{{f}_{R} ∈ {Ω}_{R}} F C ( τ ) = {\sum }_{a ∈ A} {x}_{a}^{R} ( {μ}_{t} {t}_{a} ( {x}_{a} ) - {τ}_{a} ) + {\sum }_{r} {\sum }_{s} {\sum }_{k} {f}_{R}^{rs , k} {d}^{rs , k} \qquad ( 12 a )$$

$$s . t . Eqs . ( 3 ) \qquad ( 12 b )$$

where τₐ is the subsidy of link a provided by the offset provider for each trip using link a, provided with driving flow f_{D}. In non-limiting embodiments, the transportation pricing protocol provided by the following bi-level formulation:

$${min}_{τ} z = {\sum }_{a} {x}_{a} {t}_{a} ( {x}_{a} ) + γ {\sum }_{a} {x}_{a}^{R} {τ}_{a} \qquad ( 13 a )$$

$$s . t . {τ}_{a} \geq 0 , ∀ a ∈ A \qquad ( 13 b )$$

$$Eqs . ( 3 ) \qquad ( 13 c )$$

$$f ( τ ) is a solution of problems ( 4 ) and ( 12 ) given τ \qquad ( 13 d )$$

where γ is a parameter for trade-off between system travel time and subsidy cost, and τ is the vectorized τₐ. γ is a flexible parameter to be set by the public agency. When γ is large, the goal is to use a small set of total subsidies in exchange for a small system improvement comparing to FOSC. Setting γ to small implies an aggressive strategy, where a best system performance close to SO is aimed, possibly at the price of high offsets for the offset provider. In non-limiting embodiments, f(T) can be solved using Algorithm 3 by replacing

$${c}_{R}^{rs , k} ( d ) with {c}_{R}^{rs , k} ( d , τ ) ,$$

which is given by:

$${c}_{R}^{r s , k} ( d , τ ) = {\sum }_{a} ( {μ}_{t} ( {t}_{a} ( {x}_{a} ) + {x}_{a}^{R} {t}_{a}^{′} ( {x}_{a} ) ) - {τ}_{a} ) {δ}_{a}^{rs , k} + {d}^{rs , k} \qquad ( 14 )$$

In non-limiting embodiments, two types of scenarios may be addressed, including system travel time minimization and generalized system cost minimization. In the system travel time minimization scenario, the offset provider aims to minimize system travel time regardless of the cost, wherein this scenario gives a lower bound for the system travel time with the transportation pricing protocol, namely what is the best system performance the transportation pricing protocol can achieve, provided with the current transportation service provider penetration. In the generalized system cost minimization scenario, the offset provider makes a trade-off between a substantial benefit in system travel time and a reasonable offset cost.

In non-limiting embodiments, a heuristic solution algorithm based on sensitivity analysis with respect to flow and link-based subsidy may be used to solve the transportation pricing protocol problem. The variable ∇_{τ}z is calculated to update τ.

In non-limiting embodiments, prior to calculating ∇_{τ}z, ∇_{τ}x is calculated by extending the sensitivity analysis method in Yang and Huang (2005) to the multi-class traffic assignment problems, where

$$x = {( {x}_{D}^{T} , {x}_{R}^{T} )}^{T} .$$

Sensitivity analysis is conducted on a small perturbation of subsidies T with a given set of compensations d, as part of the iterative solving process.

In non-limiting embodiments,

$$Δ = ( \begin{matrix}{Δ}_{D} & 0 \\ 0 & {Δ}_{R}\end{matrix} ) and Λ = ( \begin{matrix}{Λ}_{D} & 0 \\ 0 & {Λ}_{R}\end{matrix} )$$

are the link/path and O-D/path incidence matrices respectively, wherein only the links with positive flows and equilibrated paths are considered in the incidence matrices. In non-limiting embodiments, f and x denote an equilibrium solution, resulting in:

$$( \begin{matrix}Δ \\ Λ\end{matrix} ) f = ( \begin{matrix}x \\ q\end{matrix} ) \qquad ( 15 )$$

In non-limiting embodiments, only a maximum set of linearly independent paths in (Δ^{T}, Δ^{T})^{T} are considered and the reduced vectors and matrices are represented by. By the equilibrium condition and O-D demand conservation,

$$\tilde{c} ( f , τ ) - {\tilde{Λ}}^{T} π = 0 \qquad ( 16 )$$

$$\tilde{Λ} \tilde{f} - q = 0 \qquad ( 17 )$$

where π is the vector of the minimum path costs for two classes of vehicles of all the O-D pairs. The derivative of equations (16) and (17) with respect to T, results in:

$$( \begin{matrix}{∇}_{f} \tilde{c} ( f , τ ) & - {\tilde{Λ}}^{T} \\ \tilde{Λ} & 0\end{matrix} ) ( \begin{matrix}{∇}_{τ} \tilde{f} \\ {∇}_{τ} π\end{matrix} ) = ( \begin{matrix}- {∇}_{τ} \tilde{c} ( f , τ ) \\ 0\end{matrix} ) \qquad ( 18 )$$

where ∇_{f}\tilde{c}(f,τ) and ∇_{τ}\tilde{c}(f,τ) are calculated given d is fixed.

$${∇}_{\overline{f}} \tilde{c} ( f , τ ) = ( \begin{matrix}{\tilde{Δ}}_{D}^{T} diag ( … {t}_{a}^{′} ( {x}_{a} ) … ) {\tilde{Δ}}_{D} & {\tilde{Δ}}_{D}^{T} diag ( … {t}_{a}^{′} ( {x}_{a} ) … ) {\tilde{Δ}}_{R} \\ \begin{matrix}{\tilde{Δ}}_{D}^{T} diag ( … {μ}_{t} ( {t}_{a}^{′} ( {x}_{a} ) + \\ {x}_{a}^{R} {t}_{a}^{″} ( {x}_{a} ) ) … ) {\tilde{Δ}}_{D}\end{matrix} & \begin{matrix}{\tilde{Δ}}_{R}^{T} diag ( … {μ}_{t} ( 2 {t}_{a}^{′} ( {x}_{a} ) + \\ {x}_{a}^{R} {t}_{a}^{″} ( {x}_{a} ) ) … ) {\tilde{Δ}}_{R}\end{matrix}\end{matrix} ) \qquad ( 19 )$$

$${∇}_{τ} \tilde{c} ( f , τ ) = ( \begin{matrix}Z \\ - {\tilde{Δ}}_{R}^{T}\end{matrix} ) \qquad ( 20 )$$

wherein Z denotes a zero matrix whose shape is the same as

$${\tilde{Δ}}_{D}^{T} .$$

The inverse of the Jacobian J in Eq. (18) is:

$${J}^{- 1} = {( \begin{matrix}{∇}_{f} \tilde{c} ( f , τ ) & - {\tilde{Λ}}^{T} \\ \tilde{Λ} & 0\end{matrix} )}^{- 1} = ( \begin{matrix}{B}_{11} & {B}_{12} \\ {B}_{21} & {B}_{22}\end{matrix} ) \qquad ( 21 )$$

Then, from Eq. (18):

$${∇}_{τ} x = \tilde{Δ} {∇}_{τ} \tilde{f} = - \tilde{Δ} {B}_{11} {∇}_{τ} \tilde{c} ( f , τ ) \qquad ( 22 )$$

The gradient of [symbol] with regard to τ is

$${∇}_{τ} z = {( \frac{\partial z}{\partial x} \frac{\partial x}{\partial τ} + \frac{\partial z}{\partial τ} )}^{T} \qquad ( 23 )$$

$$where$$

$$\frac{\partial z}{\partial x} = ( … {t}_{a} ( {x}_{a} ) + {x}_{a} {t}_{a}^{′} ( {x}_{a} ) … , … , {t}_{a} ( {x}_{a} ) + {x}_{a} {t}_{a}^{′} ( {x}_{a} ) + γ {τ}_{a} … ) \qquad ( 24 )$$

$$\frac{\partial x}{\partial τ} = {∇}_{τ}^{T} x \qquad ( 25 )$$

$$\frac{\partial z}{\partial τ} = ( … γ {x}_{a}^{R} … ) \qquad ( 26 )$$

After these gradients are calculated, the set of subsidies τ is updated using the AdaGrad method.

In non-limiting embodiments, it is assumed that the link travel time function tₐ(xₐ) is a strictly monotone increasing and piece-wise linear function, ∀ₐ ∈A.

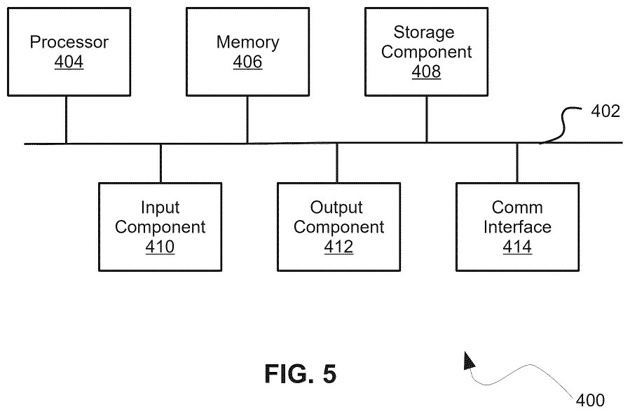

Referring now to FIG. 5, shown is a diagram of example components of a device 400 according to non-limiting embodiments or aspects. Device 400 may correspond to at least one of the computing devices referenced herein. In non-limiting embodiments or aspects, such systems or devices may include at least one device 400 and/or at least one component of device 400. The number and arrangement of components shown in FIG. 3 are provided as an example. In non-limiting embodiments or aspects, device 400 may include additional components, fewer components, different components, or differently arranged components than those shown in FIG. 3. Additionally, or alternatively, a set of components (e.g., one or more components) of device 400 may perform one or more functions described as being performed by another set of components of device 400.

As shown in FIG. 5, device 400 may include bus 402, processor 404, memory 406, storage component 408, input component 410, output component 412, and communication interface 414. Bus 402 may include a component that permits communication among the components of device 400. In non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 5, storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A method comprising:
receiving, with at least one processor, a transportation request comprising an origin and a destination within a transportation network;
determining, with the at least one processor, a plurality of routes from the origin to the destination, wherein a first route of the plurality of routes comprises at least one optimal route among the plurality of routes;
determining, for at least a subset of routes of the plurality of routes, an offset value based on traffic demand data in the transportation network, the offset value provided by a system separate and remote from the at least one processor;
determining, with the at least one processor, a selected route of the plurality of routes;
allocating, with the at least one processor, the offset value corresponding to the selected route to the transportation request; and
modifying, with the at least one processor, trip data for the selected route based on the offset value.

2. The method of claim 1, wherein the selected route is determined based on a user selection of the selected route from the subset of routes on a user computing device.

3. The method of claim 1, wherein the offset value for each route is based on at least one of the following: a difference in distance between the route and the at least one optimal route, a difference in travel time between the route and the at least one optimal route, a difference in traffic congestion between the route and the at least one optimal route, or any combination thereof.

4. The method of claim 1, wherein the offset value is at least partially determined by a system separate and remote from the at least one processor.

5. The method of claim 1, wherein modifying the trip data comprises at least one of the following: adding a credit, reducing a user fee, increasing a user fee, or any combination thereof.

6. The method of claim 1, wherein the traffic demand data comprises: (i) first traffic data associated with a fleet of vehicles assigned transportation requests in the transportation network by the at least one processor, and (ii) second traffic data associated with vehicles that are not part of the fleet of vehicles.

7. The method of claim 6, wherein the offset value for each route is based on an algorithm configured to iteratively adjust an offset vector based on a determined equilibrium of the first traffic data and the second traffic data, such that each offset value is based on the offset vector.

8. The method of claim 1, wherein the offset value for each route is based on one or more values associated with each segment of a plurality of segments in the transportation network.

9. A system comprising at least one computing device configured to:
receive a transportation request comprising an origin and a destination within a transportation network;
determine a plurality of routes from the origin to the destination, wherein a first route of the plurality of routes comprises at least one optimal route among the plurality of routes;
determine, for at least a subset of routes of the plurality of routes, an offset value based on traffic demand data in the transportation network, the offset value provided by a system separate and remote from the at least one computing device;
determine a selected route of the plurality of routes;
allocate the offset value corresponding to the selected route to the transportation request; and
modify trip data for the selected route based on the offset value.

10. The system of claim 9, wherein the selected route is determined based on a user selection of the selected route from the subset of routes on a user computing device.

11. The system of claim 9, wherein the offset value for each route is based on at least one of the following: a difference in distance between the route and the at least one optimal route, a difference in travel time between the route and the at least one optimal route, a difference in traffic congestion between the route and the at least one optimal route, or any combination thereof.

12. The system of claim 9, wherein the offset value is at least partially determined by a system separate and remote from the at least one processor.

13. The system of claim 9, wherein modifying the trip data comprises at least one of the following: adding a credit, reducing a user fee, increasing a user fee, or any combination thereof.

14. The system of claim 9, wherein the traffic demand data comprises: (i) first traffic data associated with a fleet of vehicles assigned transportation requests in the transportation network by the at least one processor, and (ii) second traffic data associated with vehicles that are not part of the fleet of vehicles.

15. The system of claim 14, wherein the offset value for each route is based on an algorithm configured to iteratively adjust an offset vector based on a determined equilibrium of the first traffic data and the second traffic data, such that each offset value is based on the offset vector.

16. The system of claim 9, wherein the offset value for each route is based on one or more values associated with each segment of a plurality of segments in the transportation network.

17. A computer program product comprising a non-transitory computer-readable medium including program instructions that, when executed by at least one computing device, cause the computing device to:
receive a transportation request comprising an origin and a destination within a transportation network;
determine a plurality of routes from the origin to the destination, wherein a first route of the plurality of routes comprises at least one optimal route among the plurality of routes;
determine, for at least a subset of routes of the plurality of routes, an offset value based on traffic demand data in the transportation network, the offset value provided by a system separate and remote from the computing device;
determine a selected route of the plurality of routes;
allocate the offset value corresponding to the selected route to the transportation request; and
modify trip data for the selected route based on the offset value.

18. The computer program product of claim 17, wherein the selected route is determined based on a user selection of the selected route from the subset of routes on a user computing device.

19. The computer program product of claim 17, wherein the offset value for each route is based on at least one of the following: a difference in distance between the route and the at least one optimal route, a difference in travel time between the route and the at least one optimal route, a difference in traffic congestion between the route and the at least one optimal route, or any combination thereof.

20. The computer program product of claim 17, wherein the offset value is at least partially determined by a system separate and remote from the at least one processor.
